(19) United States
(12) Patent Application Publication
(10) Pub. No.: US 2016/0259142 A1
(43) Pub. Date: Sep. 8, 2016

(54) Optical Fiber Stripping Apparatus and Communications Device

(71) Applicant: Huawei Technologies Co., Ltd., Shenzhen (CN)

(72) Inventors: Deyi Shi, Shenzhen (CN); Anliang Yang, Shenzhen (CN); Feng Wu, Shenzhen (CN); Yan Zhang, Shenzhen (CN)

(21) Appl. No.: 15/154,866

(22) Filed: May 13, 2016

Related U.S. Application Data
(63) Continuation of application No. PCT/CN2014/091071, filed on Nov. 14, 2014.

(30) Foreign Application Priority Data
Nov. 15, 2013 (CN) 201310576417.8

(51) Int. Cl. G02B 6/44

(52) U.S. Cl. CPC G02B 6/4497

(57) ABSTRACT

The present disclosure provides an optical fiber stripping apparatus and a communications device. In the optical fiber stripping apparatus, at least one hook is configured to buckle a hook slot of the base; and a first surface of the base is in contact with the second surface of the connecting part, and the hook slot corresponding to the at least one hook is disposed on the first surface of the base, where when the at least one hook buckles the hook slot of the base, a dowel pin of the spring pin springs up, and the dowel pin fits in the pin hole at the one side of the connecting part to fasten positions of the connecting part and the base, and when the dowel pin is pressed down, the connecting part can be disassembled from the base, which simplifies a process of mounting.

### CROSS-REFERENCE TO RELATED APPLICATIONS

This application is a continuation of International Application No. PCT/CN2014/091071, filed on Nov. 14, 2014, which claims priority to Chinese Patent Application No. 201310576417.8, filed on Nov. 15, 2013, both of which are hereby incorporated by reference in their entireties.

### TECHNICAL FIELD

The present disclosure relates to communications technologies, and in particular, to an optical fiber stripping apparatus and a communications device.

### BACKGROUND

With the development of optical fiber technologies, an optical fiber stripping apparatus is also widely applied to communications devices. FIG. 1 is a schematic structural diagram of an optical fiber stripping apparatus in the prior art, and as shown in FIG. 1, the optical fiber stripping apparatus 10 includes: a hose clamp 101, a strength member 102, a fiber protection tube 103, insulation tape 104, and a fastening plate 105. As shown in FIG. 1, an optical fiber 106 is fastened to the optical fiber stripping apparatus 10 by using the hose clamp 101, and a stripped pigtail is inserted into the fiber protection tube 103. Because there is a gap between the fiber protection tube 103 and the optical fiber, to protect an exposed optical fiber, the optical fiber at the gap needs to be manually bound by using the insulation tape 104 in the prior art. In a general case, a screw on the fastening plate 105 of the optical fiber stripping apparatus 10 is connected to the inside of a cabinet in a rigid manner. For example, as shown in FIG. 1, the fastening plate 105 is connected to the inside of the cabinet in a rigid manner by using four screws. FIG. 2 is a schematic diagram of a connection structure of an optical fiber stripping apparatus in the prior art, and the connection structure further includes: a strength member fastening post 107, a fastening clamping jaw 108 for a hose clamp 101, a clip 109, and a screw 110. The strength member fastening post 107 is disposed on a fastening plate 105, and the strength member fastening post 107 is configured to fasten a strength member 102 in an optical cable. The fastening clamping jaw 108 for the hose clamp 101 is disposed on the fastening plate 105, and as shown in FIG. 2, multiple fastening clamping jaws 108 for the hose clamp 101 may be simultaneously disposed on the one fastening plate 105 to fasten multiple optical fiber stripping apparatuses. As shown in FIG. 2, in the prior art, the multiple optical fiber stripping apparatuses are generally disposed on the one fastening plate 105, and the fastening plate 105 is connected to the inside of a cabinet in a communications device in a rigid manner by using multiple screws 110.

However, when a single optical fiber stripping apparatus needs to be disassembled for repair, multiple screws need to be disassembled because of the structure in the prior art, which causes a tedious and complex disassembly process, and in the disassembly process, normal use of another optical fiber stripping apparatus disposed on a same fastening plate is affected.

### SUMMARY

The present disclosure provides an optical fiber stripping apparatus and a communications device, which are used to improve efficiency in mounting and disassembling the optical fiber stripping apparatus.

A first aspect of the present disclosure provides an optical fiber stripping apparatus. The apparatus includes a hose clamp, a connecting part, a spring pin, a base, and at least one fiber protection tube. The hose clamp is disposed on one end of a first surface of the connecting part, and the hose clamp is configured to fasten an optical cable. A first fastening part is disposed in the middle of the first surface of the connecting part, and the first fastening part is configured to fasten a strength member of the optical cable after the optical cable is stripped. A second fastening part is disposed on another end of the first surface of the connecting part, the second fastening part is configured to fasten the at least one of fiber protection tube, and the at least one of fiber protection tube is configured to protect a pigtail. A second surface of the connecting part is in contact with the base, at least one hook is disposed on the second surface of the connecting part, and the at least one hook is configured to buckle a hook slot of the base. A first surface of the base is in contact with the second surface of the connecting part, and the hook slot corresponding to the at least one hook is disposed on the first surface of the base. The spring pin is disposed on the first surface of the base, and the spring pin has one dowel pin, where when the at least one hook buckles the hook slot of the base, the dowel pin springs up, and the dowel pin fits in a pin hole at one side of the connecting part to fasten positions of the connecting part and the base, and when the dowel pin is pressed down, the connecting part can be disassembled from the base.

With reference to the first aspect, in a first possible implementation manner, the optical fiber stripping apparatus further includes: an upper cover. At least one screw is disposed on the upper cover, and the upper cover is connected to the first fastening part in a rigid manner by using the at least one screw and is configured to protect the exposed pigtail. A tapped hole corresponding to the screw is disposed on a plane that is of the first fastening part and that is in contact with the upper cover, and the tapped hole is configured to fasten to the at least one screw of the upper cover.

With reference to the first aspect or the first possible implementation manner of the first aspect, in a second possible implementation manner, the base is in a convex structure, and the first surface of the base includes: a first subordinate surface, a second subordinate surface, and a third subordinate surface. The first subordinate surface is a convex surface, and the second subordinate surface and the third subordinate surface are concave surfaces. The first subordinate surface is in contact with the second surface of the connecting part, and the at least one hook slot is disposed on the first subordinate surface. The spring pin is riveted on the first subordinate surface, and the spring pin has one dowel pin, where when the at least one hook buckles the hook slot of the base, the dowel pin springs up, and the dowel pin fits in the pin hole at the one side of the connecting part to fasten the positions of the connecting part and the base, and when the dowel pin is pressed down, the connecting part can be disassembled from the base. A screw is disposed on the second subordinate surface and is configured to connect the base and a mounting plate in a rigid manner. A screw is disposed on the third subordinate surface and is configured to connect the base and the mounting plate in a rigid manner.

A second aspect of the present disclosure provides a communications device, including the optical fiber stripping apparatus described in the foregoing first aspect or any possible implementation manner of the first aspect, a cabinet, and a mounting plate. At least one group of tapped holes are disposed on the mounting plate, the at least one group of tapped holes are configured to fasten to at least one group of screws disposed on a base of the optical fiber stripping apparatus to fasten the optical fiber stripping apparatus to the mounting plate, and the mounting plate is connected to the inside of the cabinet in a rigid manner.

According to the optical fiber stripping apparatus provided in the embodiments, a pin hole is disposed at one side of a connecting part, a spring pin is disposed on a base, a hose clamp is disposed on one end of a first surface of the connecting part, and the hose clamp is configured to fasten an optical cable. A first fastening part is disposed in the middle of the first surface of the connecting part, and the first fastening part is configured to fasten a strength member of the optical cable after the optical cable is stripped. A second fastening part is disposed on another end of the first surface of the connecting part, the second fastening part is configured to fasten at least one of the fiber protection tube, and the at least one of the fiber protection tube is configured to protect a pigtail. A second surface of the connecting part is in contact with the base, at least one hook is disposed on the second surface of the connecting part, and the at least one hook is configured to buckle a hook slot of the base. A first surface of the base is in contact with the second surface of the connecting part, and the hook slot corresponding to the at least one hook is disposed on the first surface of the base. When the at least one hook buckles the hook slot of the base, a dowel pin of the spring pin springs up, and the dowel pin fits in the pin hole at the one side of the connecting part to fasten positions of the connecting part and the base. When the dowel pin is pressed down, the connecting part can be disassembled from the base, which simplifies a process of mounting and disassembling the optical fiber stripping apparatus and improves efficiency in mounting and disassembling the optical fiber stripping apparatus.

### BRIEF DESCRIPTION OF THE DRAWINGS

For a more complete understanding of the present invention, and the advantages thereof, reference is now made to the following descriptions taken in conjunction with the accompanying drawings, in which:

To describe the technical solutions in the embodiments of the present disclosure more clearly, the following briefly introduces the accompanying drawings required for describing the embodiments or the prior art. Apparently, the accompanying drawings in the following description show some embodiments of the present disclosure, and a person of ordinary skill in the art may still derive other drawings from these accompanying drawings without creative efforts.

FIG. 1 is a schematic structural diagram of an optical fiber stripping apparatus in the prior art;

FIG. 2 is a schematic diagram of a connection structure of an optical fiber stripping apparatus in the prior art;

FIG. 3 is a schematic structural diagram of an optical fiber stripping apparatus according to an embodiment of the present disclosure;

FIG. 4 is a schematic structural diagram of another optical fiber stripping apparatus according to an embodiment of the present disclosure;

FIG. 5 is a schematic structural diagram of a base according to an embodiment of the present disclosure;

FIG. 6 is a schematic diagram of a process of mounting an optical fiber stripping apparatus according to an embodiment of the present disclosure;

FIG. 7 is a schematic diagram of a process of disassembling an optical fiber stripping apparatus according to an embodiment of the present disclosure; and

FIG. 8 is a schematic diagram of a mounting structure of still another optical fiber stripping apparatus according to an embodiment of the present disclosure.

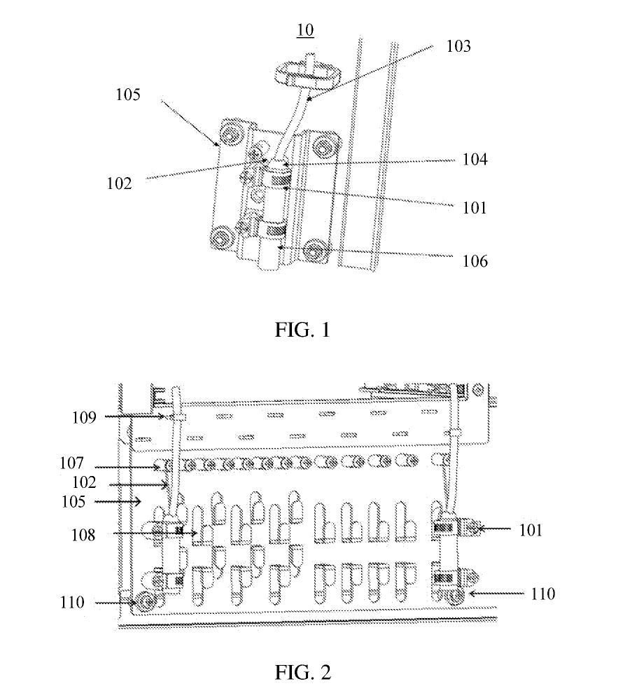

### DETAILED DESCRIPTION OF ILLUSTRATIVE EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

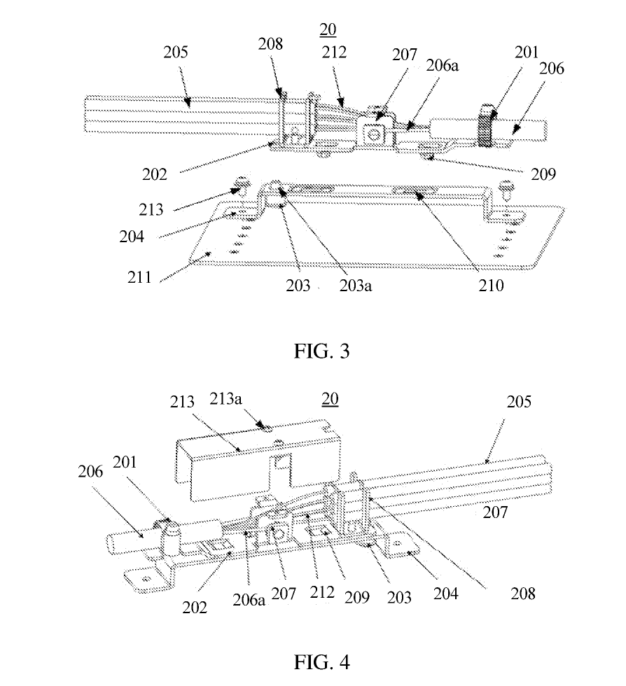

FIG. 3 is a schematic structural diagram of an optical fiber stripping apparatus 20 according to an embodiment of the present disclosure. As shown in FIG. 3, the optical fiber stripping apparatus 20 includes: a hose clamp 201, a connecting part 202, a spring pin 203, a base 204, and a fiber protection tube 205.

The hose clamp 201 is disposed on one end of a first surface of the connecting part 202, and the hose clamp 201 is configured to fasten an optical cable 206.

A first fastening part 207 is disposed in the middle of the first surface of the connecting part 202, and the first fastening part 207 is configured to fasten a strength member 206a of the optical cable 206 after the optical cable 206 is stripped.

A second fastening part 208 is disposed on another end of the first surface of the connecting part 202, the second fastening part 208 is configured to fasten at least one of the fiber protection tube 205, and the at least one of the fiber protection tube 205 is configured to protect a pigtail 212.

A second surface of the connecting part 202 is in contact with the base 204, at least one hook 209 is disposed on the second surface of the connecting part 202, and the at least one hook 209 is configured to buckle a hook slot 210 of the base 204.

A first surface of the base 204 is in contact with the second surface of the connecting part 202, and the hook slot 210 corresponding to the at least one hook 209 is disposed on the first surface of the base 204.

The spring pin 203 is disposed on the first surface of the base 204, the spring pin 203 has one dowel pin 203a, and when the at least one hook 209 buckles the hook slot 210 of the base 204, the dowel pin 203a springs up, and the dowel pin 203a fits in a pin hole at one side of the connecting part 202 to fasten positions of the connecting part 202 and the base 204.

Specifically, the base 204 is fastened to a mounting plate 211 inside a communications device by using a screw.

When the dowel pin 203a is pressed down, the connecting part 202 can be disassembled from the base 204.

According to the optical fiber stripping apparatus provided in this embodiment, a pin hole is disposed at one side of a connecting part, a spring pin is disposed on a base, a hose clamp is disposed on one end of a first surface of the connecting part, and the hose clamp is configured to fasten an optical cable; a first fastening part is disposed in the middle of the first surface of the connecting part, and the first fastening part is configured to fasten a strength member of the optical cable after the optical cable is stripped; a second fastening part is disposed on another end of the first surface of the connecting part, the second fastening part is configured to fasten at least one of the fiber protection tube, and the at least one of the fiber protection tube is configured to protect a pigtail; a second surface of the connecting part is in contact with the base, at least one hook is disposed on the second surface of the connecting part, and the at least one hook is configured to buckle a hook slot of the base; and a first surface of the base is in contact with the second surface of the connecting part, and the hook slot corresponding to the at least one hook is disposed on the first surface of the base, where when the at least one hook buckles the hook slot of the base, a dowel pin of the spring pin springs up, and the dowel pin fits in the pin hole at the one side of the connecting part to fasten positions of the connecting part and the base, and when the dowel pin is pressed down, the connecting part can be disassembled from the base, which simplifies a process of mounting and disassembling the optical fiber stripping apparatus and improves efficiency in mounting and disassembling the optical fiber stripping apparatus.

Further, to protect an optical fiber between a hose clamp and a fiber protection tube, in the prior art, the optical fiber needs to be manually bound by using insulation tape. However, in this way, additional costs of mounting a pigtail are increased and efficiency in mounting the pigtail is reduced. To resolve this problem, FIG. 4 is a schematic structural diagram of another optical fiber stripping apparatus according to an embodiment of the present disclosure. As shown in FIG. 4, the optical fiber stripping apparatus further includes an upper cover 213.

At least one screw 213a is disposed on the upper cover, and the upper cover is connected to the first fastening part 207 in a rigid manner by using the at least one screw 213a and is configured to protect the exposed pigtail 212.

A tapped hole corresponding to the screw is disposed on a plane that is of the first fastening part and that is in contact with the upper cover, and the tapped hole is configured to fasten to the at least one screw 213a of the upper cover 213.

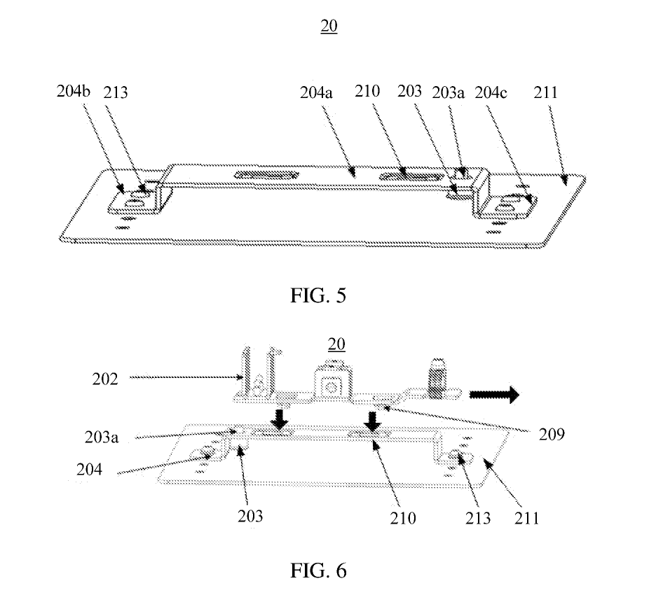

Further, FIG. 5 is a schematic structural diagram of a base according to an embodiment of the present disclosure. As shown in FIG. 5, the base 204 is in a convex structure, and the first surface of the base includes: a first subordinate surface 204a, a second subordinate surface 204b, and a third subordinate surface 204c. The first subordinate surface 204a is a convex surface, the second subordinate surface 204b is a concave surface, and the third subordinate surface 204c is a concave surface. The first subordinate surface 204a is in contact with the second surface of the connecting part 202, and the hook slot 210 corresponding to the at least one hook is disposed on the first subordinate surface 204a. The spring pin 203 is riveted on the first subordinate surface 204a, and the spring pin 203 has one dowel pin 203a, where when the at least one hook 209 buckles the hook slot 210 of the first subordinate surface 204a, the dowel pin 203a springs up, and the dowel pin 203a fits in the pin hole at the one side of the connecting part 202 to fasten the positions of the connecting part 202 and the base 204, and when the dowel pin 203a is pressed down, the connecting part 202 can be disassembled from the base 204. A screw 213 is disposed on the second subordinate surface 204b and is configured to connect the base 204 and the mounting plate 211 in a rigid manner. A screw 213 is disposed on the third subordinate surface 204c and is configured to connect the base 204 and the mounting plate 211 in a rigid manner.

The following uses an embodiment to describe how to mount the optical fiber stripping apparatus provided in this embodiment of the present disclosure on a mounting plate in a cabinet or disassemble the optical fiber stripping apparatus from a mounting plate. FIG. 6 is a schematic diagram of a process of mounting an optical fiber stripping apparatus according to an embodiment of the present disclosure. As shown in FIG. 6, a base 204 on which a spring pin 203 is riveted is first fastened to a mounting plate 211 in a cabinet by using a screw 213; along an arrow direction that is shown in FIG. 6 and that is perpendicular to a plane of the mounting plate 211, a connecting part 202 of the optical fiber stripping apparatus is buckled on the base 204 by using two hooks 209, and the spring pin 203 is used to limit a position of the optical fiber stripping apparatus. Further, during mounting, the optical fiber stripping apparatus is slid rightwards along an arrow direction that is shown in FIG. 6 and that is parallel to the plane of the mounting plate 211, and the two hooks 209 are snapped in hook slots 210 on the base until a dowel pin 203a of the spring pin 203 springs up to limit a position of the connecting part 202 of the optical fiber stripping apparatus. Further, referring to FIG. 4, after an optical fiber is stripped, an upper cover mounted with a screw is fastened to a first fastening part to protect a stripped pigtail.

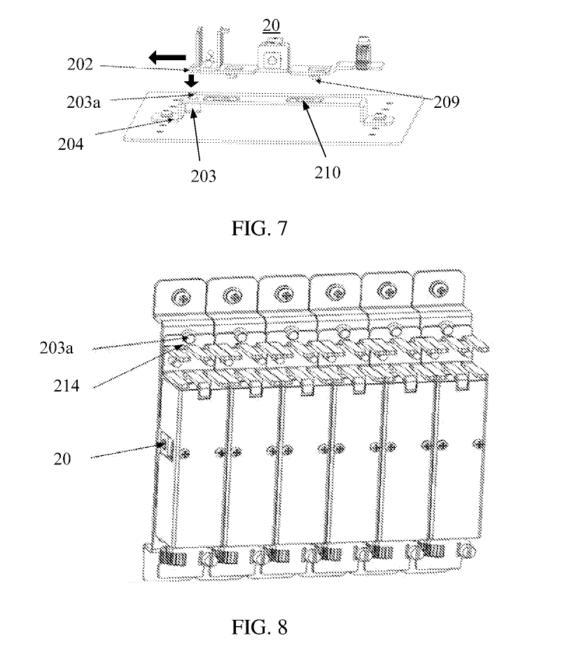

FIG. 7 is a schematic diagram of a process of disassembling an optical fiber stripping apparatus according to an embodiment of the present disclosure. As shown in FIG. 7, during disassembly, a small pointed tool is used to press down a dowel pin 203a of a spring pin 203 along an arrow direction perpendicular to a plane of a mounting plate 211, and in addition, a connecting part 202 of the optical fiber stripping apparatus is slid leftwards along an arrow direction that is shown in FIG. 7 and that is parallel to the plane of the mounting plate 211 until two hooks 209 are separated from two hook slots 210 of a base 204.

Further, FIG. 8 is a schematic diagram of a mounting structure of still another optical fiber stripping apparatus according to an embodiment of the present disclosure. As shown in FIG. 8, when multiple optical fiber stripping apparatuses 20 are mounted side by side, and when any one of the optical fiber stripping apparatuses needs to be maintained, the apparatus can be disassembled by just pressing down a dowel pin 203a of a spring pin, and maintenance can be performed without affecting another apparatus. Further, as shown in FIG. 8, a pin hole 214 is disposed on one end of a connecting part 202, and a shape of the pin hole 214 is fitted with a shape of the dowel pin 203a. For example, if the dowel pin 203a is a cylinder, the pin hole 214 is a semicircular pin hole, and a radius of the semicircle is the same as a radius of the cylinder, provided that the dowel pin 203a fits in the pin hole 214 when the dowel pin 203a springs up. It should be noted that, in this embodiment of the present disclosure, provided it can be ensured that the dowel pin 203a can fit in the pin hole 214, a specific shape of the pin hole 214 is not limited in this embodiment of the present disclosure.

An embodiment of the present disclosure further provides a communications device, where the communications device may be an optical distribution network (ODN) device such as an optical distribution frame (ODF), a fiber cross-connection cabinet, a splitting and splicing closure (SSC), or a fiber division box (FDB). Further, the communications device includes the fiber stripping apparatus described in the foregoing embodiments, a cabinet, and a mounting plate.

At least one group of tapped holes are disposed on the mounting plate, the at least one group of tapped holes are configured to fasten to at least one group of screws disposed on a base of the optical fiber stripping apparatus to fasten the optical fiber stripping apparatus to the mounting plate, and the mounting plate is connected to the inside of the cabinet in a rigid manner.

According to the communications device provided in this embodiment, at least one optical fiber stripping apparatus in the foregoing embodiments is disposed inside the communications device; and in the optical fiber stripping apparatus: a pin hole is disposed on one side of a connecting part, a spring pin is disposed on a base, a hose clamp is disposed on one end of a first surface of the connecting part, and the hose clamp is configured to fasten an optical cable; a first fastening part is disposed in the middle of the first surface of the connecting part, and the first fastening part is configured to fasten a strength member of the optical cable after the optical cable is stripped; a second fastening part is disposed on another end of the first surface of the connecting part, the second fastening part is configured to fasten at least one of the fiber protection tube, and the at least one of the fiber protection tube is configured to protect a pigtail; a second surface of the connecting part is in contact with the base, at least one hook is disposed on the second surface of the connecting part, and the at least one hook is configured to buckle a hook slot of the base; and a first surface of the base is in contact with the second surface of the connecting part, and the hook slot corresponding to the at least one hook is disposed on the first surface of the base, where when the at least one hook buckles the hook slot of the base, a dowel pin of the spring pin springs up, and the dowel pin fits in the pin hole at the one side of the connecting part to fasten positions of the connecting part and the base, and when the dowel pin is pressed down, the connecting part can be disassembled from the base, which simplifies a process of mounting and disassembling the optical fiber stripping apparatus and improves efficiency in mounting and disassembling the optical fiber stripping apparatus.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes any medium that can store program code, such as a ROM, a RAM, a magnetic disk, or an optical disc.

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An optical fiber stripping apparatus, comprising: a hose clamp, a connecting part, a spring pin, a base, and a fiber protection tube, wherein:
the hose clamp is disposed on one end of a first surface of the connecting part, and the hose clamp is configured to fasten an optical cable;
a first fastening part is disposed in a middle of the first surface of the connecting part, and the first fastening part is configured to fasten a strength member of the optical cable after the optical cable is stripped;
a second fastening part is disposed on another end of the first surface of the connecting part, the second fastening part is configured to fasten the fiber protection tube, and the fiber protection tube is configured to protect a pigtail;
a second surface of the connecting part is in contact with the base, a hook is disposed on the second surface of the connecting part, and the hook is configured to buckle a hook slot of the base;
a first surface of the base is in contact with the second surface of the connecting part, and the hook slot corresponding to the hook is disposed on the first surface of the base; and
the spring pin is disposed on the first surface of the base, and the spring pin has one dowel pin;
wherein when the hook buckles the hook slot of the base, the dowel pin is configured to spring up, and the dowel pin fits in a pin hole at one side of the connecting part to fasten positions of the connecting part and the base, and when the dowel pin is pressed down, the connecting part is configured to able to be disassembled from the base.

2. The optical fiber stripping apparatus according to claim 1, further comprising an upper cover, wherein:
a screw is disposed on the upper cover, and the upper cover is connected to the first fastening part in a rigid manner using the screw and is configured to protect the exposed pigtail; and
a tapped hole corresponding to the screw is disposed on a plane that is of the first fastening part and that is in contact with the upper cover, and the tapped hole is configured to fasten to the screw of the upper cover.

3. The optical fiber stripping apparatus according to claim 1, wherein:
the base is in a convex structure, and the first surface of the base comprises a first subordinate surface, a second subordinate surface, and a third subordinate surface;
the first subordinate surface is a convex surface, and the second subordinate surface and the third subordinate surface are concave surfaces;
the first subordinate surface is in contact with the second surface of the connecting part, and the hook slot is disposed on the first subordinate surface;
the spring pin is riveted on the first subordinate surface, and the spring pin has one dowel pin, wherein when the hook buckles the hook slot of the first subordinate surface, the dowel pin is configured to spring up, the dowel pin fits in the pin hole at the one side of the connecting part to fasten the positions of the connecting part and the base when the dowel pin springs up, and when the dowel pin is pressed down, the connecting part is configured to be able to be disassembled from the base;
a first screw is disposed on the second subordinate surface and is configured to connect the base and a mounting plate in a rigid manner; and
a second screw is disposed on the third subordinate surface and is configured to connect the base and the mounting plate in a rigid manner.

4. A communications device, comprising an optical fiber stripping apparatus, a cabinet, and a mounting plate, wherein the optical fiber stripping apparatus comprises:
a hose clamp disposed on one end of a first surface of a connecting part, the hose clamp being configured to fasten an optical cable;
a first fastening part disposed in a middle of the first surface of the connecting part, and the first fastening part is configured to fasten a strength member of the optical cable after the optical cable is stripped;
a second fastening part disposed on another end of the first surface of the connecting part, the second fastening part is configured to fasten a fiber protection tube, and the fiber protection tube is configured to protect a pigtail;
a second surface of the connecting part is in contact with a base, a hook is disposed on the second surface of the connecting part, and the hook is configured to buckle a hook slot of the base;
a first surface of the base is in contact with the second surface of the connecting part, and the hook slot corresponding to the hook is disposed on the first surface of the base;
a spring pin disposed on the first surface of the base, and the spring pin has one dowel pin, wherein when the hook buckles the hook slot of the base, the dowel pin is configured to spring up, and the dowel pin fits in a pin hole at one side of the connecting part to fasten positions of the connecting part and the base, and when the dowel pin is pressed down, the connecting part is configured to be able to be disassembled from the base; and
a group of tapped holes are disposed on the mounting plate, the group of tapped holes are configured to fasten to a group of screws disposed on a base of the optical fiber stripping apparatus to fasten the optical fiber stripping apparatus to the mounting plate, and the mounting plate is connected to the inside of the cabinet in a rigid manner.

5. The communications device according to claim 4, wherein the optical fiber stripping apparatus comprises further comprises an upper cover, and wherein:
a screw is disposed on the upper cover, and the upper cover is connected to the first fastening part in a rigid manner using the screw and is configured to protect the exposed pigtail; and
a tapped hole corresponding to the screw is disposed on a plane that is of the first fastening part and that is in contact with the upper cover, and the tapped hole is configured to fasten to the screw of the upper cover.

6. The communications device according to claim 4, wherein:
the base is in a convex structure, and the first surface of the base comprises a first subordinate surface, a second subordinate surface, and a third subordinate surface;
the first subordinate surface is a convex surface, and the second subordinate surface and the third subordinate surface are concave surfaces;
the first subordinate surface is in contact with the second surface of the connecting part, and the hook slot is disposed on the first subordinate surface;
the spring pin is riveted on the first subordinate surface, and the spring pin has one dowel pin, wherein when the hook buckles the hook slot of the first subordinate surface, the dowel pin is configured to spring up, the dowel pin fits in the pin hole at the one side of the connecting part to fasten the positions of the connecting part and the base when the dowel pin springs up, and when the dowel pin is pressed down, the connecting part is configured to be able to be disassembled from the base;
a first screw is disposed on the second subordinate surface and is configured to connect the base and a mounting plate in a rigid manner; and
a second screw is disposed on the third subordinate surface and is configured to connect the base and the mounting plate in a rigid manner.

7. A method of forming an optical fiber stripping apparatus, the optical fiber stripping apparatus comprising a hose clamp, a connecting part, a spring pin, a base, and a fiber protection tube, the method comprising:
disposing a hose clamp on one end of a first surface of the connecting part, the hose clamp being configured to fasten an optical cable;
disposing a first fastening part in a middle of the first surface of the connecting part, the first fastening part being configured to fasten a strength member of the optical cable after the optical cable is stripped;
disposing a second fastening part on another end of the first surface of the connecting part, the second fastening part being configured to fasten the fiber protection tube, and the fiber protection tube being configured to protect a pigtail;
disposing a hook on a second surface of the connecting part, the second surface of the connecting part being in contact with the base, and the hook being configured to buckle a hook slot of the base;
disposing a the hook slot corresponding to the hook is disposed on a first surface of the base, the first surface of the base being in contact with the second surface of the connecting part; and
disposing the spring pin on the first surface of the base, the spring pin having one dowel pin;
wherein when the hook buckles the hook slot of the base, the dowel pin is configured to spring up, and the dowel pin fits in a pin hole at one side of the connecting part to fasten positions of the connecting part and the base, and when the dowel pin is pressed down, the connecting part is configured to able to be disassembled from the base.

8. The method according to claim 7, wherein the optical fiber stripping apparatus further comprises an upper cover, and wherein the method further comprises:
disposing a screw on the upper cover, and the upper cover being connected to the first fastening part in a rigid manner using the screw and being configured to protect the exposed pigtail; and
disposing a tapped hole corresponding to the screw on a plane that is of the first fastening part and that is in contact with the upper cover, the tapped hole being configured to fasten to the screw of the upper cover.

9. The method according to claim 7, wherein:
the base is in a convex structure, and the first surface of the base comprises a first subordinate surface, a second subordinate surface, and a third subordinate surface;
the first subordinate surface is a convex surface, and the second subordinate surface and the third subordinate surface are concave surfaces;
the first subordinate surface is in contact with the second surface of the connecting part, and the hook slot is disposed on the first subordinate surface;
the spring pin is riveted on the first subordinate surface, and the spring pin has one dowel pin, wherein when the hook buckles the hook slot of the first subordinate surface, the dowel pin is configured to spring up, the dowel pin fits in the pin hole at the one side of the connecting part to fasten the positions of the connecting part and the base when the dowel pin springs up, and when the dowel pin is pressed down, the connecting part is configured to be able to be disassembled from the base; and
the method further comprises:
disposing a first screw on the second subordinate surface, the first screw being configured to connect the base and a mounting plate in a rigid manner; and
disposing a second screw on the third subordinate surface, the second screw being configured to connect the base and the mounting plate in a rigid manner.
